(19) United States
(12) Patent Application Publication
(10) Pub. No.: US 2021/0285378 A1
(43) Pub. Date: Sep. 16, 2021

(54) RAIL AND TUBE ASSEMBLY

(71) Applicant: Kidde Technologies, Inc., Wilson, NC (US)

(72) Inventors: Venkata Satish Babu Lakshmi, Bangalore (IN); Venkata Anil Kumar Mothe, Bangalore (IN)

(21) Appl. No.: 17/159,279

(22) Filed: Jan. 27, 2021

(30) Foreign Application Priority Data
Mar. 16, 2020 (IN) 202011011270

(51) Int. Cl. F02C 7/25; F23R 3/60; F23R 3/00

(52) U.S. Cl. CPC F02C 7/25; F23R 3/002; F23R 3/60

(57) ABSTRACT

A rail and tube arrangement includes a rail, one or more tubes spaced apart from the rail, and one or more tube supports configured to support the one or more tubes at the rail. Each tube support includes a head portion wrapped at least partially around the rail, two opposing leg portions extending from the head portion and a support portion extending from each leg portion of the two opposing leg portions, the one or more tubes disposed between the support portions. One or more fasteners extend through the two opposing leg portions applying a clamping force to the two opposing leg portions thereby securing the tube support to the rail, and retaining the one or more tubes between the support portions.

### CROSS-REFERENCE TO RELATED APPLICATIONS

This application claims the benefit of IN Provisional Application No. 202011011270 filed Mar. 16, 2020, the disclosure of which is incorporated herein by reference in its entirety.

### BACKGROUND

Exemplary embodiments pertain to the art of fire detection systems, and more particularly to rail-mounted fire detection systems for, for example, a gas turbine engine.

Many structures and apparatus, such as gas turbine engines, utilize fire and over heat detection systems to monitor locations within the apparatus for fire and/or over heat conditions. Many such systems include a rail on which one or more sensors are located, a so-called rail-mounted fire detection system. The sensors utilize sensor tubes or conduits routed to cover various possible hot air leakage zones. The sensor tubes extend along the rail and are periodically secured to the rail along the rail length.

In a typical system, the sensor tubes are secured to the rail via a dual element clamp, which is welded to the rail. The assembly is subject to high levels of vibration during operation of the engine, which subjects the assembly to high stress levels. Such high stress levels results in failure at the weld location. Further, the assembly is complex and involves a high number of parts, and is further complex to manufacture. Finally, the multiple weld joins present along the rail can result in warping of the rail.

### BRIEF DESCRIPTION

In one embodiment a rail and tube arrangement includes a rail, one or more tubes spaced apart from the rail, and one or more tube supports configured to support the one or more tubes at the rail. Each tube support includes a head portion wrapped at least partially around the rail, two opposing leg portions extending from the head portion, and a support portion extending from each leg portion of the two opposing leg portions. The one or more tubes are located between the support portions, and one or more fasteners extend through the two opposing leg portions applying a clamping force to the two opposing leg portions thereby securing the tube support to the rail, and retaining the one or more tubes between the support portions.

Additionally or alternatively, in this or other embodiments a grommet is located between and retained between the two support portions. The one or more tubes extend through the grommet.

Additionally or alternatively, in this or other embodiments the grommet is formed from one of an elastomeric, thermoplastic or rubber material.

Additionally or alternatively, in this or other embodiments the rail has a circular cross-section and the head portion has a complimentary partially circular cross-section.

Additionally or alternatively, in this or other embodiments the leg portions extend linearly from the head portion.

Additionally or alternatively, in this or other embodiments the support portions are curvilinear.

Additionally or alternatively, in this or other embodiments the one or more tubes are sensor tubes of a fire and overheat detection system.

Additionally or alternatively, in this or other embodiments the one or more fasteners is one or more bolts.

In another embodiment, a gas turbine engine includes a combustor section, a turbine section driven by combustion products of the combustor section, and a fire and overheat detection system including a rail, and one or more sensor tubes spaced apart from the rail. The one or more sensor tubes are configured to predict a temperature rise due to leakages and generate a signal indicating an unexpected temperature increase. One or more tube supports are configured to support the one or more sensor tubes at the rail. Each tube support includes a head portion wrapped at least partially around the rail, two opposing leg portions extending from the head portion, and a support portion extending from each leg portion of the two opposing leg portions. The one or more tubes are located between the support portions. One or more fasteners extend through the two opposing leg portions applying a clamping force to the two opposing leg portions thereby securing the tube support to the rail, and retaining the one or more sensor tubes between the support portions.

Additionally or alternatively, in this or other embodiments a grommet is located between and retained between the two support portions. The one or more sensor tubes extend through the grommet.

Additionally or alternatively, in this or other embodiments the grommet is formed from one of an elastomeric, thermoplastic or rubber material.

Additionally or alternatively, in this or other embodiments the rail has a circular cross-section and the head portion has a complimentary partially circular cross-section.

Additionally or alternatively, in this or other embodiments the leg portions extend linearly from the head portion.

Additionally or alternatively, in this or other embodiments the support portions are curvilinear.

Additionally or alternatively, in this or other embodiments the one or more fasteners is one or more bolts.

In yet another embodiment, a method of assembling a tube and rail arrangement includes providing one or more tube supports, locating one or more tubes spaced apart from a rail, and sliding the one or more tube supports onto the rail. Each tube support includes a head portion wrapped at least partially around the rail, two opposing leg portions extending from the head portion and a support portion extending from each leg portion of the two opposing leg portions. The one or more tubes are located between the support portions. One or more fasteners are installed through the opposing leg portions, thereby applying a clamping force to the two opposing leg portions thereby securing the tube support to the rail, and retaining the one or more tubes between the support portions.

Additionally or alternatively, in this or other embodiments a grommet is installed between the two support portions. The one or more tubes extend through the grommet.

Additionally or alternatively, in this or other embodiments the rail has a circular cross-section and the head portion has a complimentary partially circular cross-section.

Additionally or alternatively, in this or other embodiments the leg portions extend linearly from the head portion.

Additionally or alternatively, in this or other embodiments the support portions are curvilinear.

### BRIEF DESCRIPTION OF THE DRAWINGS

The following descriptions should not be considered limiting in any way. With reference to the accompanying drawings, like elements are numbered alike:

FIG. 1 is a partial cross-sectional view of an embodiment of a gas turbine engine;

FIG. 2 is a perspective view of an embodiment of a rail and tube arrangement;

FIG. 3 is another perspective view of an embodiment of a rail and tube arrangement; and

FIG. 4 is a cross-sectional view of an embodiment of a rail and tube arrangement.

### DETAILED DESCRIPTION

A detailed description of one or more embodiments of the disclosed apparatus and method are presented herein by way of exemplification and not limitation with reference to the Figures.

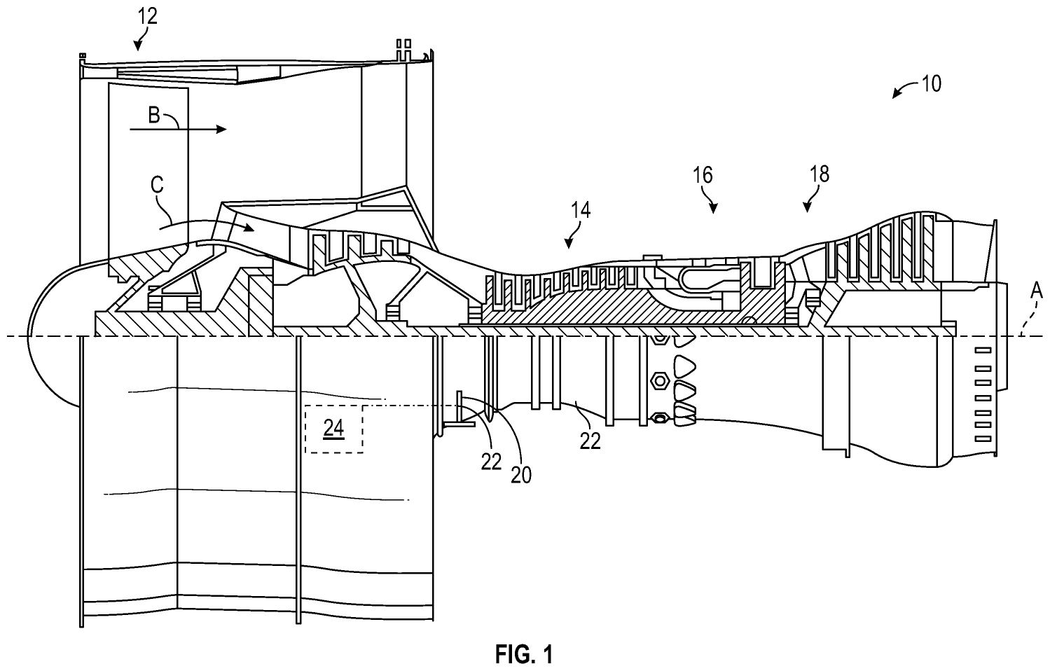

Shown in FIG. 1 is an embodiment of a gas turbine engine 10. The gas turbine engine 10 is disclosed herein as a two-spool turbofan that generally incorporates a fan section 12, a compressor section 14, a combustor section 16 and a turbine section 18. Alternative engines might include an augmenter section (not shown) among other systems or features. The fan section 12 drives air along a bypass flow path B in a bypass duct, while the compressor section 14 drives air along a core flow path C for compression and communication into the combustor section 16 then expansion through the turbine section 18. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures. A fire and overheat detection system (FODS) 20 is located at the gas turbine engine 10 and may be, for example, secured to a static structure of the gas turbine engine 10. The FODS 20 is configured such that sensor elements are exposed to fluid flow at or around the gas turbine engine 10 and detect a change in temperature of the fluid flow which may be indicative of a fire or overheat condition. The FODS 20 utilizes a plurality of sensor tubes 22 which are located throughout the gas turbine engine 10 to various possible hot air leakage zones of the gas turbine engine 10. The sensor tubes 22 are equipped with necessary technology to predict a temperature rise due to leakages and generate a signal indicating an unexpected temperature increase, which is output to, for example, an engine control system 24.

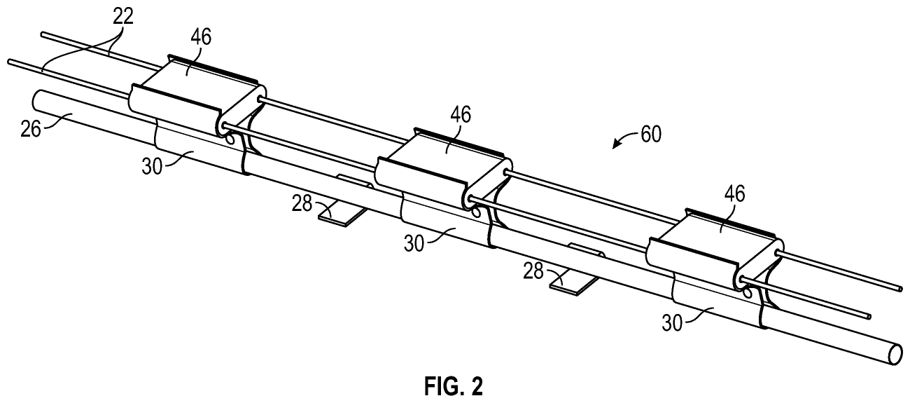

The sensor tubes 22 are arrayed along and supported by a rail 26, such as shown in more detail in FIG. 2. A plurality of rail supports 28 are secured to the rail 26 and are utilized to secure the rail 26 to the static structure of the gas turbine engine 10. A plurality of tube supports 30 are utilized to support the sensor tubes 22 at the rail 26.

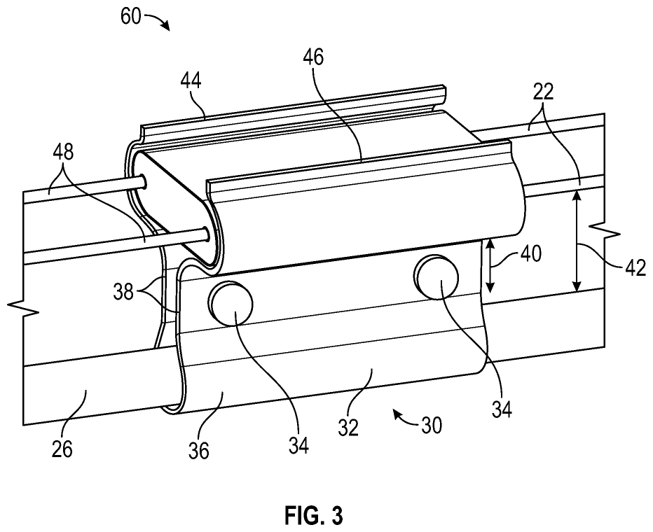

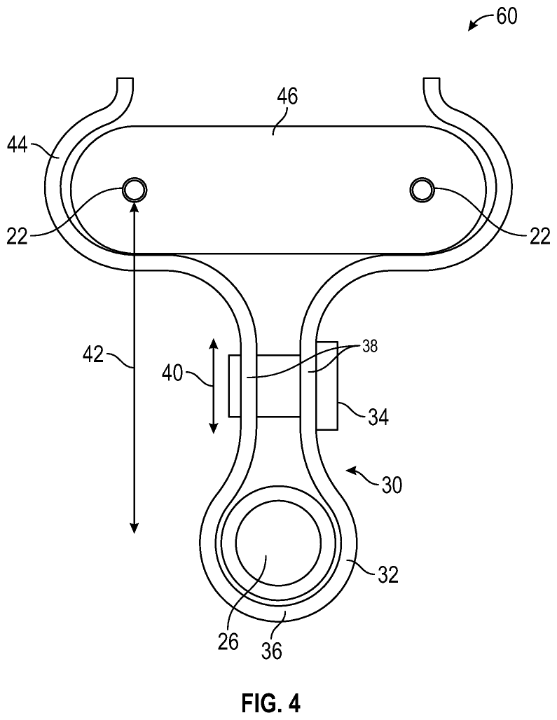

Referring now to FIGS. 3 and 4, an exemplary embodiment of a tube and rail assembly 60 is illustrated. The tube support 30 is, in some embodiments, formed from a metal material. The tube support 30 includes a support body 32, which wraps around the rail 26 and is secured at the rail 26 via a clamping force applied via one or more bolts 34 or other fasteners, such as screws or the like. More particularly, the support body 32 includes a head portion 36, which wraps at least partially around the rail 26, and two opposing leg portions 38 extending from the head portion 36. In some embodiments, such as shown, the rail 26 has a circular cross-section and the head portion 36 has a complimentary partially circular cross-section to locate and secure the tube support 30 at the rail 26. It is to be appreciated, however, that other rail 26 cross-sections, such as oval, polygonal or the like, and other complimentary head portion 36 cross-sections may be utilized.

While the head portion 36, such as illustrated, has a curvilinear cross-sectional shape, the leg portions 38 may be planar, extending linearly from the head portion 36 for a leg length 40. The leg length 40 is established to provide a selected tube offset 42 between the sensor tubes 22 and the rail 26. A support portion 44 of the tube support 30 extends from each of the leg portions 38. The support portions 44 as shown are shaped and configured to retain a support grommet 46 located between opposing support portions 44. The sensor tubes 22 pass through grommet openings 48 in the support grommet 46, and the support grommet 46 is formed and configured to isolate the sensor tubes 22 from external vibrational forces due to engine operation. In some embodiments, the support grommet 46 is formed from, for example, an elastomeric or rubber material, but support grommets 46 formed from other materials, such as a thermoplastic material, for example, PTFE, are contemplated within the scope of the present disclosure. In some embodiments, the support grommet 46 is a partially rectangular cross-sectional shape such as shown in the illustrated embodiment, other shapes of support grommets 46 such as circular, polygonal or the like, are contemplated within the scope of the present disclosure. Further, while two sensor tubes 22 are illustrated in the assembly shown herein, other quantities of sensor tubes 22, such as one, three or more sensor tubes 22 may be routed through the support grommet 46.

As stated above, the one or more bolts 34 are utilized to secure the tube support 30 at the rail 26. In particular, the bolts 34 are installed through the opposing leg portions 38 of the tube support 30. The tightening of the bolts 34 at the leg portions 38 applies a clamping force at the leg portions 38, drawing the leg portions 38 toward each other. This clamping force, in turn, brings the head portion 36 into frictional contact with the rail 26 to secure the tube support 30 at the rail 26 via the frictional contact between the rail 26 and the head portion 36. Utilizing the bolts 34 to secure the tube support 30 to the rail 26 allows for adjustment of the position of the tube support 30 along the rail 26 simply by loosening the bolts 34 and sliding the tube support 30 along the rail 26 to a new position. The bolts 34 are then tightened to secure the tube support 30 to the rail 26 at the new position.

Installation of the bolts 34 in the leg portions 38 further acts to secure the support grommet 46 between the opposing support portions 44. The tightening of the bolts 34 at the leg portions 38 applies the clamping force at the leg portions 38, drawing the leg portions 38 toward each other. This clamping force, in turn, brings the opposing support portions 44 into frictional contact with the support grommet 46 to secure the support grommet 46 between the opposing support portions 44 via the frictional contact between the support grommet 46 and the support portions 44.

The tube and rail assembly 60 of the present disclosure improves capability of withstanding vibrational forces when compared to typical configurations. The tube and rail assembly 60 is a modular configuration that is readily adaptable for multiple applications, of which FODS 20 is an example. The positions of the tube supports 30 along the rail are readily adjustable based on application and engine mount requirements, and ease of assembly is improved over the typical welded configuration. The configuration allows for supporting multiple sensor tubes 22 at the tube support 30 via a single support grommet 46, and reduced the number of parts in the assembly, providing cost and weight reduction benefits.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out the present disclosure, but that the present disclosure will include all embodiments falling within the scope of the claims.

What is claimed is:

1. A rail and tube arrangement, comprising:
a rail;
one or more tubes spaced apart from the rail; and
one or more tube supports configured to support the one or more tubes at the rail, each tube support including:
a head portion wrapped at least partially around the rail;
two opposing leg portions extending from the head portion;
a support portion extending from each leg portion of the two opposing leg portions, the one or more tubes disposed between the support portions; and
one or more fasteners extending through the two opposing leg portions applying a clamping force to the two opposing leg portions thereby securing the tube support to the rail, and retaining the one or more tubes between the support portions.

2. The rail and tube arrangement of claim 1, further comprising a grommet disposed between and retained between the two support portions, the one or more tubes extending through the grommet.

3. The rail and tube arrangement of claim 2, wherein the grommet is formed from one of an elastomeric or rubber material.

4. The rail and tube arrangement of claim 1, wherein the rail has a circular cross-section and the head portion has a complimentary partially circular cross-section.

5. The rail and tube arrangement of claim 1, wherein the leg portions extend linearly from the head portion.

6. The rail and tube arrangement of claim 1, wherein the support portions are curvilinear.

7. The rail and tube arrangement of claim 1, wherein the one or more tubes are sensor tubes of a fire and overheat detection system.

8. The rail and tube arrangement of claim 1, wherein the one or more fasteners is one or more bolts.

9. A gas turbine engine, comprising:
a combustor section;
a turbine section driven by combustion products of the combustor section; and
a fire and overheat detection system including:
a rail;
one or more sensor tubes spaced apart from the rail, the one or more sensor tubes configured to predict a temperature rise due to leakages and generate a signal indicating an unexpected temperature increase; and
one or more tube supports configured to support the one or more sensor tubes at the rail, each tube support including:
a head portion wrapped at least partially around the rail;
two opposing leg portions extending from the head portion;
a support portion extending from each leg portion of the two opposing leg portions, the one or more tubes disposed between the support portions; and
one or more fasteners extending through the two opposing leg portions applying a clamping force to the two opposing leg portions thereby securing the tube support to the rail, and retaining the one or more sensor tubes between the support portions.

10. The gas turbine engine of claim 9, further comprising a grommet disposed between and retained between the two support portions, the one or more sensor tubes extending through the grommet.

11. The gas turbine engine of claim 10, wherein the grommet is formed from one of an elastomeric or rubber material.

12. The gas turbine engine of claim 9, wherein the rail has a circular cross-section and the head portion has a complimentary partially circular cross-section.

13. The gas turbine engine of claim 9, wherein the leg portions extend linearly from the head portion.

14. The gas turbine engine of claim 9, wherein the support portions are curvilinear.

15. The gas turbine engine of claim 9, wherein the one or more fasteners is one or more bolts.

16. A method of assembling a tube and rail arrangement, comprising:
providing one or more tube supports;
locating one or more tubes spaced apart from a rail;
sliding the one or more tube supports onto the rail, each tube support including:
a head portion wrapped at least partially around the rail;
two opposing leg portions extending from the head portion;
a support portion extending from each leg portion of the two opposing leg portions, the one or more tubes disposed between the support portions; and
installing one or more fasteners through the opposing leg portions, thereby applying a clamping force to the two opposing leg portions thereby securing the tube support to the rail, and retaining the one or more tubes between the support portions.

17. The method of claim 16, further comprising installing a grommet between the two support portions, the one or more tubes extending through the grommet.

18. The method of claim 16, wherein the rail has a circular cross-section and the head portion has a complimentary partially circular cross-section.

19. The method of claim 16, wherein the leg portions extend linearly from the head portion.

20. The method of claim 16, wherein the support portions are curvilinear.
